(19) United States
(12) Patent Application Publication
(10) Pub. No.: US 2019/0131055 A1
(43) Pub. Date: May 2, 2019

(54) ISOLATION TRANSFORMER, A SWITCH DRIVING CIRCUIT AND A PULSE POWER SYSTEM

(71) Applicant: General Electric Company, Schenectady, NY (US)

(72) Inventor: Saijun MAO, Shanghai (CN)

(21) Appl. No.: 16/154,745

(22) Filed: Oct. 9, 2018

(30) Foreign Application Priority Data
Oct. 26, 2017 (CN) 201711012712.5

(51) Int. Cl. H01F 27/28; H01F 27/29; H02M 3/335; H01F 19/08; H01F 27/34

(52) U.S. Cl. CPC H01F 27/2804; H01F 27/292; H02M 3/3353; H01F 2019/085; H01F 27/34; H01F 2027/2819; H01F 19/08

(57) ABSTRACT

An isolation transformer, comprising: a primary winding printed on a first substrate; a shorted winding printed on a second substrate; and a secondary winding printed on a third substrate. The shorted winding is magnetically coupled to the primary winding; the secondary winding is magnetically coupled with the shorted winding. Embodiments of the present invention also relate to a switch driving circuit and a pulse power system.

### TECHNICAL FIELD

Embodiments of the present invention relate to an isolation transformer, a switch driving circuit and a pulse power system.

### BACKGROUND ART

Common-mode interference is a typical problem in switch circuits. The existence of common-mode interference will bring many negative impacts to the normal operation of the circuit, such as: electromagnetic interference, false detection, false triggering, current waveform distortion, and so on; especially in the case of a slotted semiconductor power device using high-speed broadband, common-mode interference is even more severe. Common-mode interference can often be reduced by adding a capacitive coupling path to the isolation transformer. For example, a dual isolation transformer structure is used to reduce the capacitance from the primary circuit to the secondary circuit.

FIG. 1 is a schematic structural view (side view) of a double isolation transformer 100 used in prior art. Referring to FIG. 1, the dual isolation transformer 100 comprises a primary-side winding 110, a single-turn winding 120, a secondary-side winding 130, a first toroidal core 140, and a second toroidal core 150. The primary-side winding 110 is wound around the surface of the first toroidal core 140 along the circumferential direction of the first toroidal core 140; similarly, the secondary-side winding 130 is wound around the surface of the second toroidal core 150 along the circumferential direction of the second toroidal core 150, the first and second toroidal cores 140, 150 are substantially coaxially disposed, the single-turn winding 120 is substantially disposed a long the axial direction of the first and second toroidal cores 140, 150 and passes through the center holes of the first and second toroidal cores, such that the single-turn winding is magnetically coupled to the primary-side winding and the secondary-side winding simultaneously.

As can be seen from FIG. 1, this double isolation transformer requires two toroidal cores to enhance the magnetic coupling between the windings, therefore, it takes a large space in both the horizontal and vertical directions, which will bring certain difficulties for the compactness and planarization of the entire driving circuit.

In addition, since the windings around the toroidal cores are mainly wound by hand, this will bring challenges to the mass production and cost control of related products.

Therefore, it is necessary to provide a new isolation transformer, switch driving circuit, and pulse power system to solve at least one of the above problems.

### SUMMARY OF THE INVENTION

An embodiment of the present invention relates to an isolation transformer, comprising a primary winding printed on a first substrate; a shorted winding printed on a second substrate; and a secondary winding printed on a third substrate. The shorted winding is magnetically coupled to the primary winding; the secondary winding is magnetically coupled with the shorted winding.

Another aspect of an embodiment of the present invention relates to a switch driving circuit, comprising a voltage converting module, an isolation transformer module coupled to an output of the voltage converting module, and a gate driver coupled to an output of the isolation transformer. The voltage converting module is configured to convert a driving voltage into a first AC voltage; the isolating transformer module is configured to convert the first AC voltage into a second AC voltage; the gate driver is configured to receive the second AC voltage and generate a gate driving signal. wherein the isolation transformer module comprises: a primary winding printed on a first substrate; a shorted winding printed on a second substrate; and a secondary winding printed on a third substrate. The shorted winding is magnetically coupled to the primary winding; the secondary winding is magnetically coupled with the shorted winding.

Another aspect of an embodiment of the present invention relates to a pulse power system, coupled to a load, comprising: a direct voltage source, an energy storage device and a switch circuit module. The direct voltage source comprises an output which is coupled with the load. The energy storage device is coupled with the output of the direct voltage source; the switch circuit module is coupled between the direct voltage source and the energy storage device, and configured to transfer energy from the direct voltage source to the energy storage device, or from the energy storage device to the direct voltage source. The switch circuit module comprising: a plurality of switch units; and a driving circuit, coupled to the switch units and configured to drive the switch units. The driving circuit comprising an isolation transformer, which comprises: a primary winding printed on a first substrate, a shorted winding printed on a second substrate; and a secondary winding printed on a third substrate. The shorted winding is magnetically coupled to the primary winding; the secondary winding is magnetically coupled with the shorted winding.

### BRIEF DESCRIPTION OF THE DRAWINGS

When reading the following detailed description with reference to the accompanying drawings, these and other features, aspects, and advantages of the present invention will become better understood; in the drawings, the same reference numerals are used throughout the drawings to refer to the same components, wherein:

FIG. 1 is a schematic structural view of a double isolation transformer used in prior art;

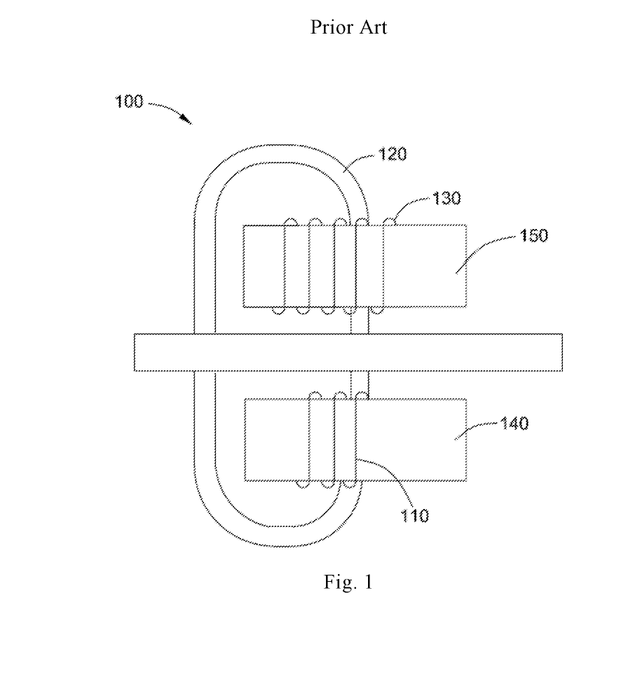

FIG. 2 is a perspective view of an isolation transformer according to an embodiment of the present invention;

FIG. 3. is a perspective view of an isolation transformer according to another embodiment of the present invention;

FIG. 4 is a side view of the isolation transformer shown in FIG. 3;

FIG. 5 is the top view of an isolation transformer according to another embodiment of the present invention;

FIG. 6 is a schematic diagram of a switch driving circuit according to an embodiment of the present invention; and

FIG. 7 is a schematic diagram of a pulse power system according to an embodiment of the present invention.

### PREFERRED EMBODIMENTS

To assist those skilled in the art to understand the claimed subject matter, specific embodiments of the present invention are described in detail below with reference to the accompanying drawings. In the following detailed description of these specific embodiments, the present specification does not describe in detail any of the known functions or configurations, to avoid unnecessary details that may affect the disclosure of the present invention.

Unless otherwise defined, the technical and scientific terms used in the claims and the specification are as they are usually understood by those skilled in the art to which the present invention pertains. “First”, “second” and similar words used in this specification and in the claims do not denote any order, quantity or importance, but are merely intended to distinguish between different constituents. The terms “one”, “a” and similar words are not meant to be limiting, but rather denote the presence of at least one. “Comprising”, “consisting of” and similar words mean that the elements or articles appearing before “comprising” or “consisting of” include the elements or articles and their equivalent elements appearing behind “comprising” or “consisting of”, not excluding any other elements or articles. “Connected”, “coupled” and similar words are not restricted to physical or mechanical connections, but may also include electrical connections, whether direct or indirect.

An embodiment of the present invention relates to an isolating transformer that is widely applicable to switch driving circuits to provide electrical isolation between modules.

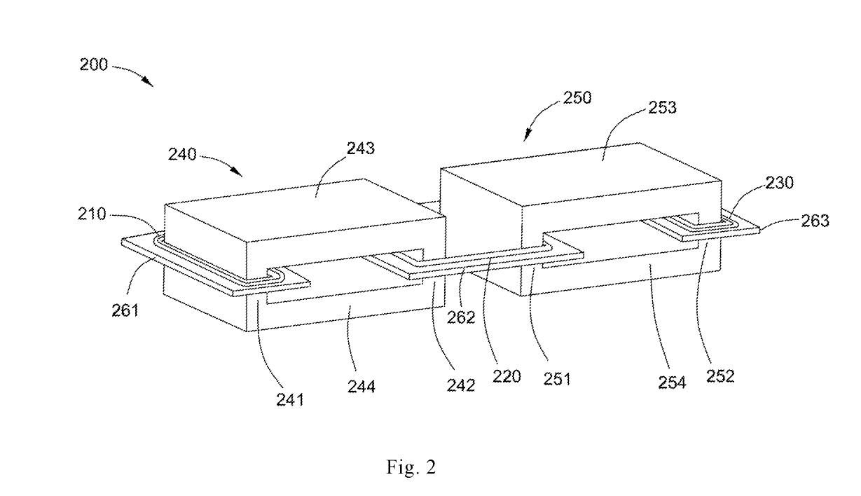

FIG. 2 is a perspective view of an isolation transformer 200 according to an embodiment of the present invention. Referring to FIG. 2, the isolation transformer 200 comprises a primary winding 210, a shorted winding 220, and a secondary winding 230. The primary winding 210 is printed on the first substrate 261, the shorted winding 220 is printed on the second substrate 262, and the secondary winding 230 is printed on a third substrate 263. The shorted winding 220 is magnetically coupled to the primary winding 210 and the secondary winding 230 simultaneously.

The first, second, and third substrates 261, 262, and 263 may be located in different planes, or they may be located substantially in the same plane. The primary winding, the shorted winding, and the secondary winding may be printed in the same layer on the respective substrates, or they may be printed in different layers on the respective substrates.

The isolation transformer 200 further comprises a first planar magnetic core 240 and a second planar magnetic core 250. The first planar magnetic core 240 is configured between the primary winding 210 and the shorted winding 220, for enhancing the magnetic coupling between the primary winding 210 and the shorted winding 220. The second planar magnetic core 250 is configured between the shorted winding 220 and the secondary winding 230, for enhancing the magnetic coupling between the shorted winding 220 and the secondary winding 230.

Specifically, the first planar magnetic core 240 comprises: a first leg 241, a second leg 242, a first upper portion 243, and a first lower portion 244. The primary winding 210 surrounds the first leg 251, the shorted winding 220 surrounds the second leg 242. The first and second legs 241, 242 are opposite to each other and communicate with each other through the first upper portion 243 and the first lower portion 244; specifically, the first upper portion 243 extends from the first end of the first leg 241 to the first end of the second leg 242, the first lower portion 244 extends from the second end of the first leg 241 to the second end of the second leg 242. In the embodiment shown in FIG. 2, the first, second, and third substrates are located substantially in the same plane, the first upper portion 243 is located on the first side of the plane that the first, second, and third substrates are located, while the first lower portion 244 is located on the second side of the plane, that is: the plane is located between the first upper portion 243 and the first lower portion 244. In some embodiments, the first upper portion 243 and the first lower portion 244 have a generally flat shape, and further, are generally parallel to the plane. In some embodiments, the first leg 241, the second leg 242, the first upper portion 243, and the first lower portion 244 generally constitute a hollow cylindrical body having a rectangular cross section.

Similarly, the second planar magnetic core 250 comprises a third leg 251, a fourth leg 252, a second upper portion 253, and a second lower portion 254. The shorted winding 220 surrounds the third leg 251, the secondary winding 230 surrounds the fourth leg 252. The third and fourth legs 251, 252 are opposite to each other and communicate with each other through the second upper portion 253 and the second lower portion 254; specifically, the second upper portion 253 extends from the first end of the third leg 251 to the first end of the fourth leg 252, the second lower portion 254 extends from the second end of the third leg 251 to the second end of the fourth leg 252. In the embodiment shown in FIG. 2, the first, second, and third substrates are located substantially in the same plane, the second upper portion 253 is located on the first side of the plane that the first, second, and third substrates are located, while the second lower portion 254 is located on the second side of the plane; that is: the plane is located between the second upper portion 253 and the second lower portion 254. The second upper portion 253 and the second lower portion 254 have a generally flat shape, and further, are generally parallel to the plane. In some embodiments, the third leg 251, the fourth leg 252, the second upper portion 253, and the second lower portion 254 generally constitute a hollow cylindrical body having a rectangular cross section.

In some embodiments, the primary winding 210 comprises a first wire in a first spiral shape printed on the first substrate 261, the shorted winding 220 comprises a second wire in a ring shape printed on the second substrate 262, and the secondary winding 230 comprises a third wire in a second spiral shape printed on the third substrate 263. The first leg 241 passes through the center hole of the first spiral shape, the second and third legs 242, 251 pass through the center hole of the second wire, and the fourth leg 252 passes through the center hole of the second spiral shape.

In the embodiment shown in FIG. 2, the shorted winding 220 is a single-turn shorted winding. In other embodiments, the shorted winding may also be a multi-turn shorted winding.

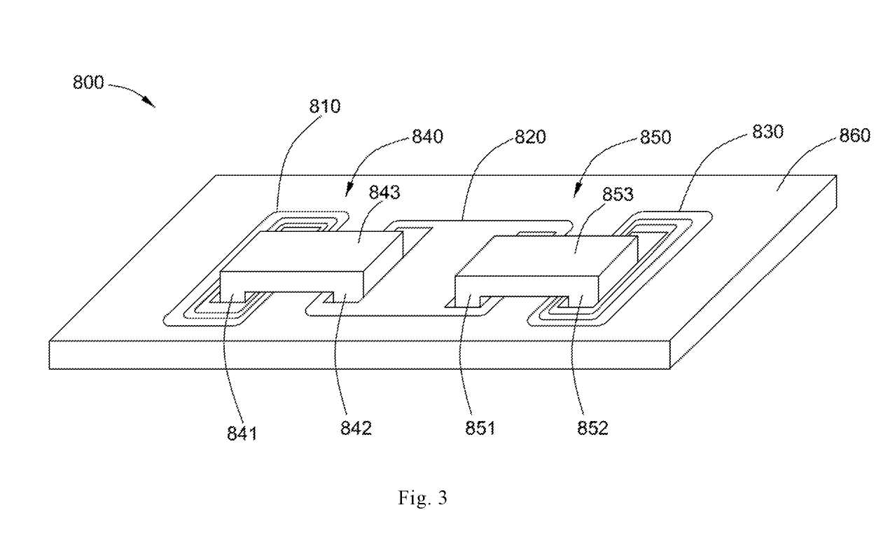

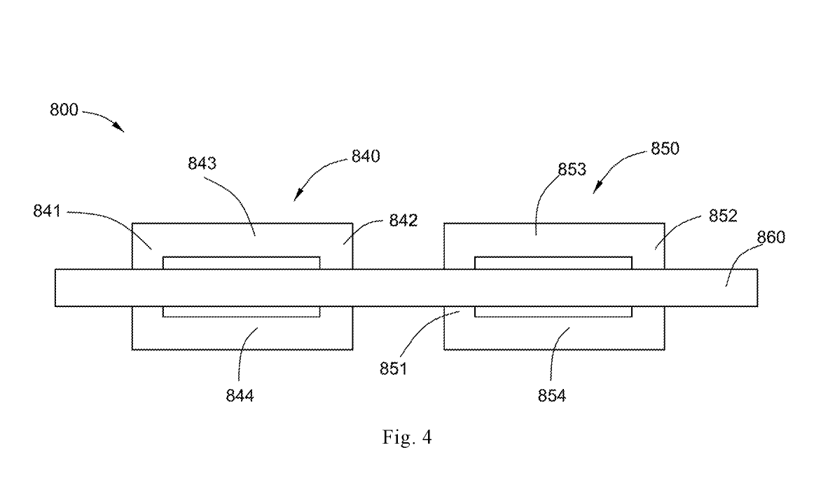

In some embodiments, as shown in FIGS. 3 and 4, the first, second, and third substrates are each a part of the same mother substrate, that is, they are integrally configured on the same mother substrate. Referring to FIGS. 3 and 4, the isolation transformer 800 comprises a mother substrate 860, a primary winding 810, a shorted winding 820, a secondary winding 830, a first planar magnetic core 840, and a second planar magnetic core 850.

The primary winding 810, the shorted winding 820, and the secondary winding 830 are printed on the mother substrate 860, and their structures and functions are similar to those of the primary winding 210, the shorted winding 220, and the secondary winding 230 in the embodiment shown in FIG. 2, respectively, and will not described herein again.

The first planar magnetic core 840 comprises a first leg 841, a second leg 842, a first upper portion 843, and a first lower portion 844; the second planar magnetic core 850 comprises a third leg 851, a fourth leg 852, a second upper portion 853 and a second lower portion 854. The structures and functions of the first planar magnetic core 840 and the second planar magnetic core 850 are similar to those of the first planar magnetic core 240 and the second planar magnetic core 250 shown in FIG. 2, respectively, and will not be described herein again.

A first through hole penetrating the depth of the mother substrate 860 is configured on the mother substrate at the center hole of the primary winding 810, and the first leg 841 of the first planar magnetic core 840 passes through the first through hole, so that the primary winding 810 surrounds it. A second through hole and a third through hole penetrating through the depth of the mother substrate 860 are configured on the mother substrate at the center hole of the shorted winding 820, and the second leg 842 of the first planar magnetic core 840 passes through the second through hole, the third leg 851 of the second planar magnetic core 850 passes through the third through hole, such that the shorted winding 820 surrounds the second and third legs. A fourth through hole penetrating the depth of the mother substrate 860 is configured on the mother substrate at the center hole of the secondary winding 830, and the fourth leg 852 of the second planar magnetic core 850 passes through the fourth through hole, such that the secondary winding 830 surrounds it. The mother substrate 860 is located between the first upper portion 843 and the first lower portion 844 of the first planar magnetic core 840, it is also located between the second upper portion 853 and the second lower portion 854 of the second planar magnetic core 850. In some other embodiments, the second and third through holes may be merged into a fifth through hole (not shown) through which the second leg 842 and the third leg 851 can pass through simultaneously.

In some embodiments, the inter-turn capacitance can be further reduced by providing a plurality of magnetically coupled shorted windings in sequence between the primary winding and the secondary winding, to further suppress common mode interference.

Specifically, the shorted winding comprises N shorted sub-windings arranged in sequence, wherein N is a natural number greater than or equal to two. The N shorted sub-windings are magnetically coupled in sequence; that is, the first shorted sub-winding is magnetically coupled to the second shorted sub-winding, the second shorted sub-winding is magnetically coupled to the third shorted sub-winding, and so on, wherein the N−1th shorted sub-winding and the N-th shorted sub-winding are magnetically coupled. Additionally, the first shorted sub-winding of the N shorted sub-windings is magnetically coupled to the primary winding, and the last shorted sub-winding of the N shorted sub-windings is magnetically coupled to the secondary winding.

In some embodiments, the isolation transformer further comprises N+1 planar magnetic cores, respectively located between the primary winding and the first shorted winding, between the N−1th winding and the Nth winding, and between the Nth winding and the secondary winding, for enhancing the magnetic coupling between the windings magnetically coupled to each other. Specifically, the first of the N+1 planar magnetic cores is coupled between the primary winding and the first shorted sub-winding, the last of the N+1 planar magnetic cores is coupled between the last shorted sub-winding and the secondary winding, and each of the other planar magnetic cores is coupled between each two adjacent shorted sub-windings.

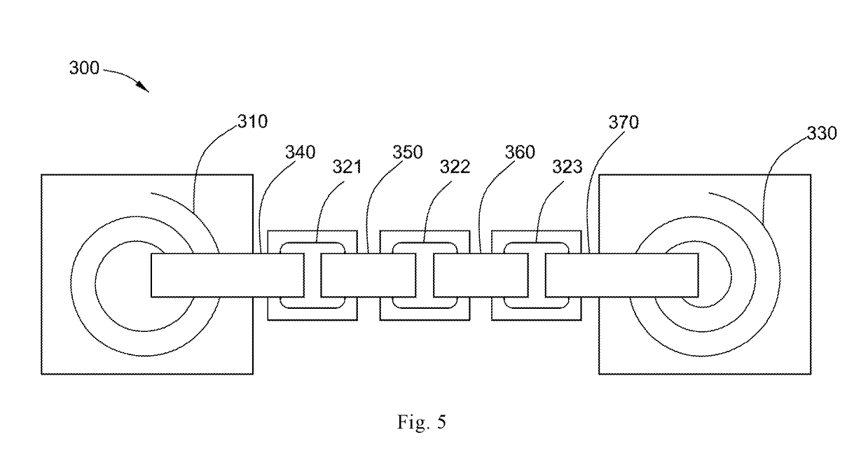

A detailed description will be made below with reference to FIG. 5, whereby N=3 in the embodiment shown in FIG. 5. Referring to FIG. 5, the isolation transformer 300 comprises a primary winding 310, a secondary winding 330, a first shorted sub-winding 321, a second shorted sub-winding 322, a third shorted sub-winding 323, a first magnetic core 340, a second magnetic core 350, a third magnetic core 360 and a fourth magnetic core 370. The primary winding 310 and the first shorted sub-winding 321 are magnetically coupled to each other by a first magnetic core 340; the first shorted sub-winding 321 is magnetically coupled to the second shorted winding 322 through a second magnetic core 350; the second shorted winding 322 is magnetically coupled to the third shorted winding 323 through a third magnetic core 360; the third shorted winding 323 is magnetically coupled to the secondary winding 330 through the fourth magnetic core 370.

Other components and other structures of the isolation transformer 300 are similar to the isolation transformer 200 shown in FIG. 2, and will not be described herein again.

Embodiments of the present invention also relate to a switch driving circuit comprising the above-described isolation transformer, which can be used to drive a power semiconductor switching device, such as a silicon power switching device, a silicon carbide power switching device, a gallium nitride power switching device, etc., such that common mode noise can still be effectively suppressed by these switching devices under high frequency operation.

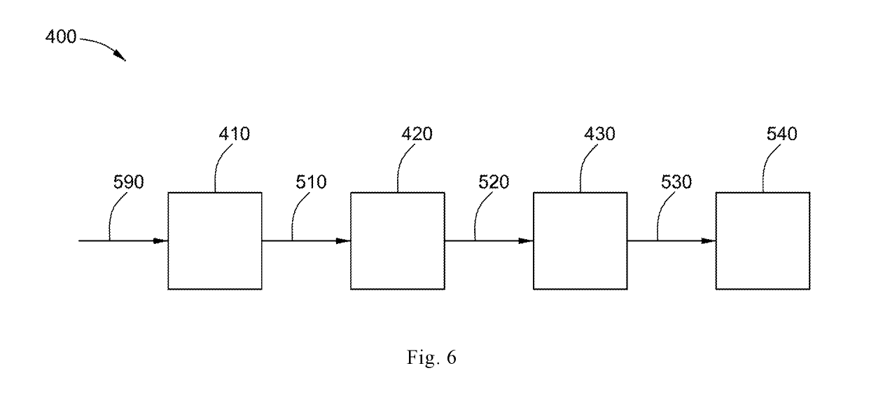

Referring to FIG. 6, the switch driving circuit 400 comprises a voltage conversion module 410, an isolation transformer module 420, and a gate driver 430. The voltage conversion module 410 is configured to convert 590 the driving voltage into a first AC voltage 510. The isolation transformer module 420 is coupled to the output of the voltage conversion module 410 for converting the first AC voltage 510 into a second AC voltage 520. The gate driver 430 is coupled to the output of the isolation transformer module 420 for receiving the second AC voltage 520 and transmitting a gate drive signal 530 to the switching device 540.

The specific structure and function of the isolation transformer module 420 are similar to the isolation transformers 200, 800 or 300 shown in FIG. 2, FIG. 3 or FIG. 5, and will not be described herein again.

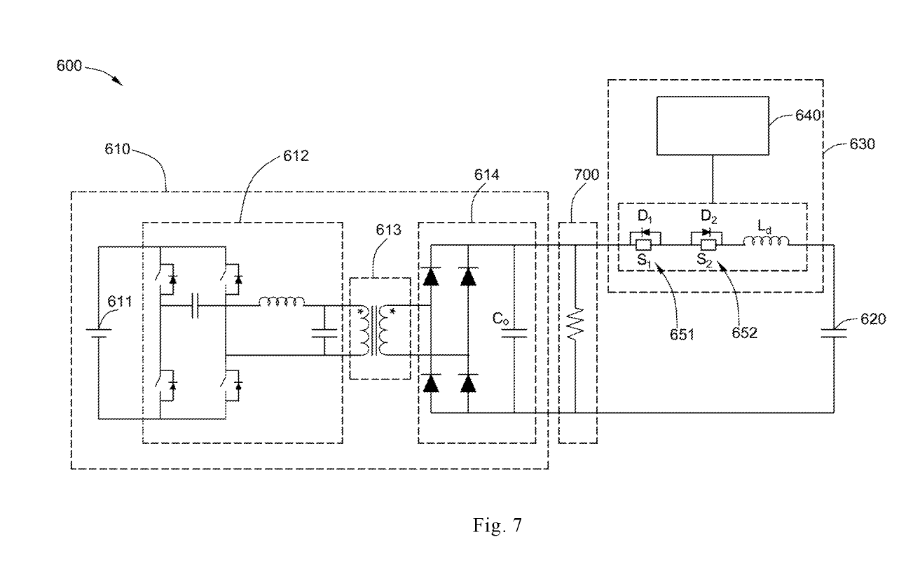

Embodiments of the present invention also relate to a pulse power system for providing a pulse voltage to a load. FIG. 7 is a schematic diagram of a pulse power system 600 according to an embodiment of the present invention. Referring to FIG. 7, the pulse power system 600 generally comprises a DC voltage source 610, an energy storage device 620, and a switch circuit module 630 for supplying a pulse voltage to the load 700. The load 700 is coupled to the output of the DC voltage source 610, and the energy storage device 620 is operatively coupled to the output of the DC voltage source 610. The switch circuit module 630 is coupled between the DC voltage source 610 and the energy storage device 620 for transferring energy from the DC voltage source 610 to the energy storage device 620 or from the energy storage device 620 to the DC voltage source 610. The energy storage device can be a capacitor 620.

The DC voltage source 610 is used to output energy, ie: a DC voltage; in the embodiment shown in FIG. 7, the DC voltage source 610 comprises a battery 611, an inverter 612, a transformer 613, a rectifier 614, and a capacitor Cₒ. The battery 611 is used to output a DC low voltage, the inverter 612 is used to convert the DC low voltage into an AC low voltage, the transformer 613 is used to convert the AC low voltage into an AC high voltage, and the rectifier 614 is used to convert the AC high voltage into a DC high voltage. The capacitor Cₒ is used to stabilize the DC high voltage.

The switch circuit 630 comprises a plurality of switch units 651, 652, a resonant inductor L_{d}, and a drive circuit 640 coupled to the switch unit, the drive circuit 640 is for driving the switch units 651, 652; each switch unit comprises a switch and diodes in parallel to the switch at both ends. In particular, in some embodiments, the drive circuit 640 can be coupled to the gate of the switch to drive the switch unit by transmitting a drive signal to the gate. The drive circuit 640 controls the switches in the switch unit to be periodically turned on or off, to transfer energy from the DC voltage source 610 to the energy storage device 620 in the first mode, or to transfer energy from the energy storage device 620 to the DC voltage source 610 in the second mode, to form a pulse voltage at both ends of the load 700.

In the embodiment shown in FIG. 7, the plurality of switch units comprises a first switch unit 651 and a second switch unit 652, that are coupled in series with each other between the DC voltage source 610 and the energy storage device 620. The first switch unit 651 comprises a first switch S₁ and a first diode D₁ connected in parallel therewith; the second switch unit 652 comprises a second switch S₂ and a second diode D₁ connected in parallel therewith. In some embodiments, the switching devices S₁, S₂ comprise power semiconductor switching devices. In some embodiments, the switching devices S₁, S₂ comprise a silicon switching device, a silicon carbide switching device, a gallium nitride switching device, or a combination thereof.

The first diode D₁ and the second diode D₂ are connected in reverse series. In some embodiments, the cathode of the first diode D₁ may be connected to the cathode of the second diode D₂, the anode of the first diode D₁ may be connected to the output of the DC voltage source 610, and the anode of the second diode D₂ may be coupled to the energy storage device 620 via a resonant inductor L_{d}.

In the embodiment shown in FIG. 7, the anode of the first diode D₁ is connected to the anode of the second diode D₂, and the cathode of the first diode D₁ is connected to the output of the DC voltage source 610, the cathode of the second diode D₂ is connected to the energy storage device 620 via the resonant inductor L_{d}.

In the first mode, the driving circuit 640 turns on the first switch S₁ and turns off the second switch S₂, at this time, energy is transferred from the DC power source 610 to the energy storage device 620 via the first switch S₁, the second diode D₂, and the resonant inductor L_{d}, the energy storage device 620 receives and stores the energy from the DC power source 610, and the voltage at both ends of the energy storage device 620 rises rapidly, forming a rising edge of the pulse voltage at both ends of the load 700.

In the second mode, the driving circuit 640 turns off the first switch S₁ and turns on the second switch S₂, at this time, the energy is transferred from the energy storage device 620 to the DC power source 610 via the resonant inductor L_{d}, the second switch S₂, and the first diode D₁. Thus, the voltage at both ends of the energy storage device 620 drops rapidly, forming a falling edge of the pulse voltage at both ends of the load 700.

Different from the prior art where the energy is consumed by the resistor, in the above embodiment, an active discharge circuit is formed by an energy storage device such as a capacitor and a switch circuit, such that a rapid discharge of the power source can be realized, thereby meeting the performance requirements for fast or ultra-fast pulse power system.

The structure and function of the driving circuit 640 are similar to those of the switching driving circuit 400 shown in FIG. 6, and will not be described herein again.

While the present invention has been described in detail with reference to specific embodiments thereof, it will be understood by those skilled in the art that many modifications and variations can be made in the present invention. It is, therefore, to be understood that the appended claims are intended to cover all such modifications and variations insofar as they are within the true spirit and scope of the invention.

What is claimed:

1. An isolation transformer, comprising:
a primary winding printed on a first substrate;
a shorted winding printed on a second substrate and magnetically coupled to the primary winding; and
a secondary winding printed on a third substrate and magnetically coupled to the shorted winding.

2. The isolation transformer according to claim 1, wherein the first, second and third substrate are at least one of: located substantially in a same plane or parts of a same mother substrate.

3. The isolation transformer according to claim 1, further comprising a first planar magnetic core which comprises:
a first leg, surrounded by the primary winding; and
a second leg, surrounded by the shorted winding.

4. The isolation transformer according to claim 3, wherein the first planar magnetic core further comprises:
a first upper portion extending from a first end of the first leg to a first end of the second leg; and
a first lower portion extending from a second end of the first leg to a second end of the second leg;
wherein the first, second and third substrate are at least one of: located substantially in a same plane or parts of a same mother substrate, and the mother substrate or the plane where the first, second and third substrate are located is between the first upper portion and the first lower portion.

5. The isolation transformer according to claim 1, further comprising a second planar magnetic core which comprises:
a third leg, surrounded by the shorted winding; and
a fourth leg, surrounded by the secondary winding.

6. The isolation transformer according to claim 5, wherein the second planar magnetic core further comprises:
a second upper portion, extending from a first end of the third leg to a first end of the fourth leg; and
a second lower portion, extending from a second end of the third leg to a second end of the fourth leg;
wherein the first, second and third substrate are at least one of: located substantially in a same plane or parts of a same mother substrate, and the mother substrate or the plane where the first, second and third substrate are located is between the second upper portion and the second lower portion.

7. The isolation transformer according to claim 1, wherein the shorted winding comprises a signal-turn winding.

8. The isolation transformer according to claim 1, wherein the primary winding comprises a first wire in a first spiral shape, the shorted winding comprises a second wire in a ring shape, and the secondary winding comprises a third wire in a second spiral shape.

9. The isolation transformer according to claim 1, wherein the shorted winding comprises N shorted sub-windings arranged in series, wherein N is a natural number greater than or equal to 2, a first shorted sub-winding of the N shorted sub-windings is magnetically coupled with the primary winding, and a last shorted sub-winding of the N shorted sub-windings is magnetically coupled with the secondary winding.

10. The isolation transformer according to claim 9, further comprising N+1 planar magnetic cores; wherein a first one of the N+1 planar magnetic cores is coupled between the primary winding and the first shorted sub-winding, a last one of the N+1 planar magnetic cores is coupled between the last shorted sub-winding and the secondary winding, and each of the other planar magnetic cores is coupled between each two adjacent shorted sub-windings respectively.

11. A switch driving circuit, comprising:
a voltage converting module, configured to convert a driving voltage into a first alternating voltage;
an isolation transformer coupled to an output of the voltage converting module and configured to transform the first alternating voltage into a second alternating voltage; and
a gate driver coupled to an output of the isolation transformer and configured to receive the second alternating voltage and generate a gate driving signal;
wherein the isolation transformer comprises:
a primary winding printed on a first substrate,
a shorted winding printed on a second substrate and magnetically coupled to the primary winding, and
a secondary winding printed on a third substrate and magnetically coupled to the shorted winding.

12. The switch driving circuit according to claim 11, wherein the first, second and third substrate are at least one of: located substantially in a same plane or parts of a same mother substrate.

13. The switch driving circuit according to claim 11, further comprising:
a first planar magnetic core coupled between the primary winding and the shorted winding; and
a second planar magnetic core coupled between the shorted winding and the secondary winding.

14. The switch driving circuit according to claim 11, wherein the shorted winding comprises a signal-turn winding.

15. A pulse power system coupled to a load, comprising:
a direct voltage source, comprising an output which is coupled with the load;
an energy storage device, coupled with the output of the direct voltage source; and
a switch circuit module, coupled between the direct voltage source and the energy storage device and configured to transfer energy from the direct voltage source to the energy storage device or from the energy storage device to the direct voltage source, the switch circuit module comprising:
a plurality of switch units, and
a driving circuit, coupled to the switch units and configured to drive the switch units, the driving circuit comprising an isolation transformer which comprises:
a primary winding printed on a first substrate,
a shorted winding printed on a second substrate and magnetically coupled to the primary winding, and
a secondary winding printed on a third substrate and magnetically coupled to the shorted winding.

16. The pulse power system according to claim 15, wherein the energy storage device comprises a capacitor.

17. The pulse power system according to claim 15, wherein the plurality of switch units comprises a first switch unit and a second switch unit coupled in series between the direct voltage source and the energy storage device;
the first switch unit comprises a first switch and a first diode coupled in parallel with the first switch;
the second switch unit comprises a second switch and a second diode coupled in parallel with the second switch; and
an anode of the first diode is connected with an anode of the second diode, or a cathode of the first diode is connected with a cathode of the second diode.

18. The pulse power system according to claim 15 wherein the first, second and third substrate are at least one of: located substantially in a same plane or parts of a same mother substrate.

19. The pulse power system according to claim 15, further comprising:
a first planar magnetic core coupled between the primary winding and the shorted winding; and
a second planar magnetic core coupled between the shorted winding and the secondary winding.

20. The switch driving circuit according to claim 15, wherein the switch unit comprises a silicon switch device, a silicon carbide switch device, a gallium nitride switch device or a combination thereof.
